(19) United States
(12) Patent Application Publication
(10) Pub. No.: US 2015/0357702 A1
(43) Pub. Date: Dec. 10, 2015

(54) ELECTRONIC APPARATUS PROVIDED WITH PROXIMITY DETECTION SENSOR CIRCUIT FOR WIRELESS COMMUNICATION CIRCUIT

(71) Applicant: Panasonic Intellectual Property Management Co., Ltd., Osaka (JP)

(72) Inventors: Kazuya TANI, Osaka (JP); Yasuharu MATSUOKA, Osaka (JP)

(21) Appl. No.: 14/829,953

(22) Filed: Aug. 19, 2015

Related U.S. Application Data
(63) Continuation of application No. PCT/JP2013/007403, filed on Dec. 17, 2013.

(30) Foreign Application Priority Data
Feb. 21, 2013 (JP) 2013-032048

(51) Int. Cl. H01Q 1/24; G01B 7/00

(52) U.S. Cl. CPC H01Q 1/24; G01B 7/003

(57) ABSTRACT

An electronic apparatus includes a first pattern conductor; a second pattern conductor electromagnetically coupled with the first pattern conductor, the second pattern conductor including a plurality of sub-pattern conductors; a band rejection filter which connects the plurality of sub-pattern conductors with each other; a wireless communication circuit with which the first pattern conductor is connected; and a proximity detection sensor circuit with which the second pattern conductor is connected.

### CROSS-REFERENCE TO RELATED APPLICATIONS

This is a continuation application of International Application No. PCT/JP2013/007403 with an international filing date of Dec. 17, 2013, which claims priority of Japanese Patent Application No. 2013-032048 filed on Feb. 21, 2013, the content of which is incorporated herein by reference.

### BACKGROUND OF THE INVENTION

1. Technical Field

The present disclosure relates to an electronic apparatus that includes a proximity detection sensor circuit, an antenna element, and a wireless communication circuit.

2. Description of the Related Art

### BACKGROUND ART

In recent years, wireless services such as mobile phones have been widely spread, and use of a communication apparatus, for example, in a state that the communication apparatus contacts closely with and is mounted on a human body has been proposed. Conventionally, there have been concerns about effects of electromagnetic waves generated by communication apparatuses on a human body, and thus, in many countries, subject apparatuses of wireless apparatuses have been designated, and laws and regulations for regulating a Specific Absorption Rate (SAR) of the subject apparatuses have been enforced. In this case, for example, regulatory values of local SAR have been set to 2.0 W/kg (10 g average) in Japan and Europe and 1.6 W/kg (1 g average) in the United States. Further, such regulations have been strengthened, for example, the subject part of a human body, which had been first limited to the head part, has been extended to the other parts of the human body.

In order to solve the issues described above, a method of mounting a proximity sensor for detecting a human body in a communication apparatus and controlling transmission output from a communication module has been proposed. In this case, the proximity sensor for detecting a capacitance value of an electrode has an advantage of widely detecting such locations that the sensor electrode extends.

As a proximity sensor mounted in the communication apparatus for detecting a human body as described above, various electrostatic proximity detection sensors have been proposed (for example, See Patent Literature 1). However, when a sensor electrode for a proximity detection sensor circuit is mounted near a wireless communication antenna in order to detect a peripheral region of the antenna where the SAR is relatively high, a mounting space increases and the antenna performance deteriorates (for example, See Patent Literature 2).

The patent literatures related to the present disclosure are as follows:

Patent Literature 1: Japanese patent laid-open publication No. JP H7-029467 A; and

Patent Literature 2: Japanese patent laid-open publication No. JP 2007-270516 A.

### SUMMARY OF INVENTION

An object of the present disclosure is to provide an electronic apparatus including a sensor electrode for a proximity detection sensor circuit, which is mounted near a wireless communication antenna in order to detect a peripheral region of the antenna where the SAR is relatively high, where the electronic apparatus is capable of avoiding increasing of a mounting space and preventing deteriorating of antenna performance.

An electronic apparatus according to the present disclosure includes a first pattern conductor; a second pattern conductor electromagnetically coupled with the first pattern conductor, the second pattern conductor including a plurality of sub-pattern conductors; a band rejection filter which connects the plurality of sub-pattern conductors with each other; a wireless communication circuit with which the first pattern conductor is connected; and a proximity detection sensor circuit with which the second pattern conductor is connected.

The present disclosure can provide an electronic apparatus including a proximity sensor which is mounted near a wireless communication antenna in order to detect a peripheral region of the antenna where the SAR is relatively high, where the electronic apparatus is capable of avoiding increasing of a mounting space and preventing deteriorating of antenna performance.

### BRIEF DESCRIPTION OF THE DRAWINGS

FIG. 1 is a block diagram showing a configuration of a proximity detection antenna apparatus for use in an electronic apparatus according to a first embodiment.

FIG. 2A is a plan view showing pattern conductors formed on a first surface 50a of a dielectric substrate 50 of an antenna sensor unit 1 of FIG. 1.

FIG. 2B is a transparent plan view showing pattern conductors, which are depicted with dotted lines, on a second surface 50b of the dielectric substrate 50 of the antenna sensor unit 1 of FIG. 1.

FIG. 3 is a circuit diagram showing a configuration of an electrostatic proximity detection sensor circuit 2 of FIG. 1.

FIG. 4 is a waveform chart showing a signal voltage generated by the electrostatic proximity detection sensor circuit 2 of FIG. 3.

FIG. 5 is a waveform chart showing a detected voltage detected by the electrostatic proximity detection sensor circuit 2 of FIG. 3.

FIG. 6 is a graph showing experimental results of the proximity detection antenna apparatus of FIG. 1, and showing frequency characteristics of a voltage standing wave ratio (VSWR) of a pattern conductor 19 which is an antenna element.

FIG. 7 is a perspective view showing an external view of an electronic tablet 100, which is an electronic apparatus including the proximity detection antenna apparatus of FIG. 1 mounted in an upper peripheral portion 101 of the electronic tablet 100.

FIG. 8A is a plan view showing a first modified embodiment of pattern conductors 11, 12, 13, and 19 of FIG. 1.

FIG. 8B is a plan view showing a second modified embodiment of the pattern conductors 11, 12, 13, and 19 of FIG. 1.

FIG. 8C is a plan view showing a third modified embodiment of the pattern conductors 11, 12, 13, and 19 of FIG. 1.

### DETAILED DESCRIPTION OF THE EMBODIMENTS

With reference to the drawings as necessary, embodiments are described in detail below. However, unnecessarily detailed descriptions may be omitted. For example, detailed descriptions for already well-known matters or redundant descriptions for substantially the same configurations may be omitted. Such omission is intended to prevent the following descriptions from being unnecessarily redundant and to facilitate understanding by those skilled in the art.

It should be noted that the applicant provides the accompanying drawings and the following descriptions for enabling those skilled in the art to fully understand the present disclosure and that the applicant does not intend to limit the scope of matters described in the claims by the accompanying drawings and the following descriptions.

As described above, in the conventional art, since a sensor electrode for a proximity detection sensor circuit has been needed to be mounted near a wireless communication antenna in order to detect a peripheral region of the antenna where the SAR is relatively high, there have been such problems that a mounting space increases and the antenna performance deteriorates. Further, in a case where a wireless communication apparatus has a metallic housing for blocking electromagnetic waves, an antenna element is needed to be pulled out of the metallic housing in order to ensure a wireless performance. However, since a capacitance-type sensor electrode is also subjected to arrangement constraint in the metallic housing, there has been issues to achieve both of arrangements of the antenna element and the sensor electrode provided near the antenna. In order to solve the above-described problems and issues, the inventors invented an electronic apparatus including a proximity detection antenna apparatus as described as follows.

### First Embodiment

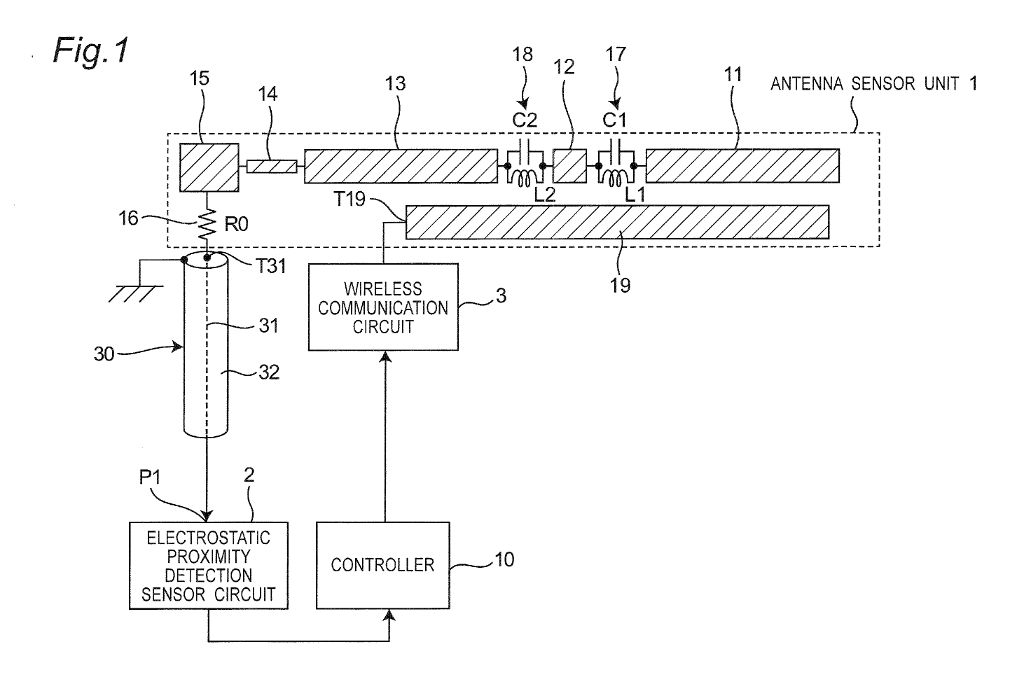

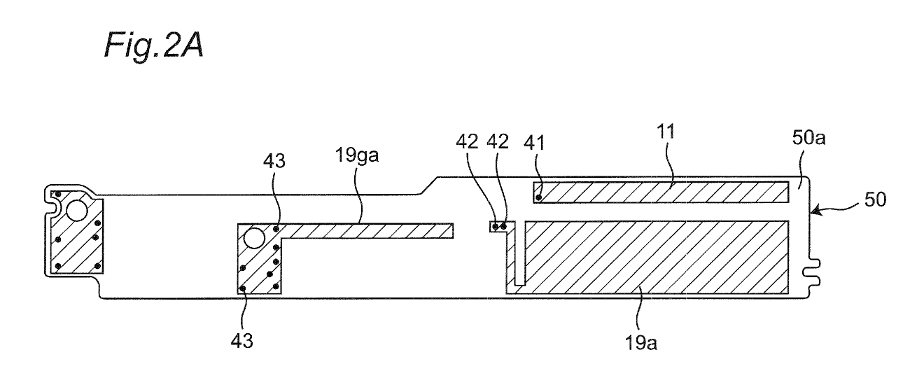

FIG. 1 is a block diagram showing a configuration of a proximity detection antenna apparatus for use in an electronic apparatus according to a first embodiment. Referring to FIG. 1, the proximity detection antenna apparatus according to the first embodiment is provided as a module that achieves a communication function in an electronic apparatus such as a personal computer, a mobile phone, or the like. The proximity detection antenna apparatus is configured to include an antenna sensor unit 1 formed on a dielectric substrate 50 shown in FIGS. 2A and 2B, a coaxial cable 30 which connects the antenna sensor unit 1 with an electrostatic proximity detection sensor circuit 2, the electrostatic proximity detection sensor circuit 2, and a controller 10 having a processor which controls transmitting electric power of a wireless communication circuit 3. In this case, a pattern conductor 19 is connected with the wireless communication circuit 3 via a terminal T19 of a feeding point.

The antenna sensor unit 1 includes the pattern conductor (first pattern conductor) 19, which is an antenna element of the wireless communication circuit 3, and a sensor element unit. The pattern conductor 19 resonates at a plurality of bands including frequencies f1 and f2 to operate as a multiple band antenna element. The sensor element unit is configured to include a sensor element (second pattern conductor) which is divided into a plurality of pattern conductors 11, 12, and 13, a band rejection filter 17 inserted between the pattern conductors 11 and 12, a band rejection filter 18 inserted between the pattern conductors 12 and 13, a pattern conductor 14 having a meander shape and configuring an inductor for stopping high frequency, a pattern conductor 15 for connection, for example, having a rectangular shape, and a resistor for stopping high frequency having a relatively high resistance value R0. The resistance value RU has a high impedance for a high-frequency when viewed from the sensor element unit, and therefore, the effects of cables, components, and the like further connected with the sensor element unit can be reduced. In an example of FIG. 1, the pattern conductor 11, the band rejection filter 17, the pattern conductor 12, the band rejection filter 18, the pattern conductors 13 to 15, and the resistor 16 are connected in series in the order thereof, and are formed on the dielectric substrate 50. In addition, the pattern conductor 19 and the pattern conductors 11, 12, and 13 are formed in proximity to and in substantially parallel to each other, so as to be electromagnetically coupled with each other. In this case, each of the band rejection filters 17 and 18 is a parallel resonance circuit connected in parallel by including an inductor, for example, having a coil shape, and an equivalent capacitance, and each of the band rejection filters 17 and 18 stops passage of a high-frequency signal in a predetermined band of frequencies. According to the configuration described above, high frequency characteristics when viewed from the resistance value R0, regarding the sensor element unit consisting of a series of sensor elements including the pattern conductors 11 to 15 and the band rejection filter 17 and 18, become such characteristics having almost no resonance at the frequencies f1 and f2 used in the wireless communication by the antenna. It is noted that the band rejection filter 17 operating at the resonance frequency f1 is mounted, for example, at a position such that each of element lengths of the pattern conductors 13 to 15, 11, and 12 becomes an electrical length that is not used in the wireless communication. In addition, each band rejection filter 18 operating at the resonance frequency f2 is mounted, for example, at a position such that each of the element lengths of the pattern conductors 12 to 15 and 11 becomes an electrical length that is not used in the wireless communication. These configurations can allow the sensor element unit consisting of a series of sensor elements including the pattern conductors 11 to 15 and the band rejection filters 17 and 18 to prevent the resonance from occurring in frequency bands mainly used in the wireless communication. As a result, isolation from adjacent antenna elements can be improved, and deterioration of antenna performance can be suppressed.

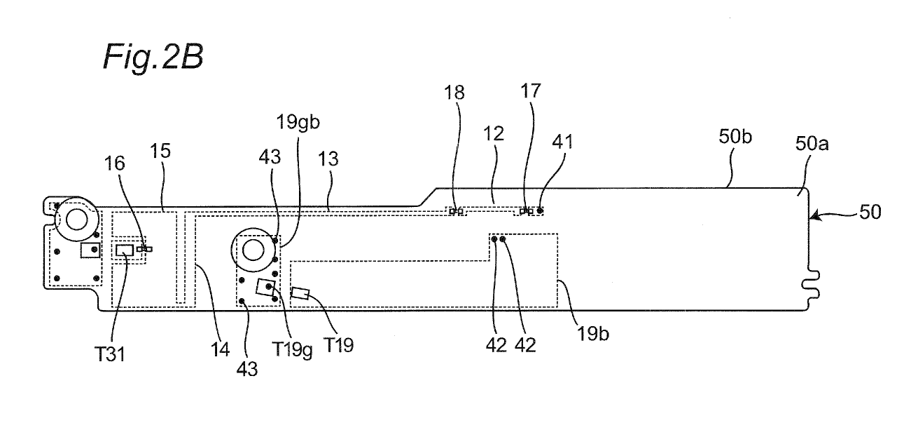

One end of the resistor 16 is connected with a connection point P1 (a detection terminal of FIG. 3) of the electrostatic proximity detection sensor circuit 2 through the terminal T31 and the coaxial cable (also referred to as a shield cable) 31. More concretely, the connection point P1 is connected with the terminal T31 through an inner conductor 31 of the coaxial cable 30. The coaxial cable 30 is configured by including the inner conductor 31 and an outer conductor 32. The both ends of the outer conductor 32 are grounded. The coaxial cable 30 is capable of transmitting a wireless communication signal with a low loss. In the coaxial cable 30, since the electrostatic capacitance value between the inner conductor and the outer conductor can be regulated to be constant (for example, 100 pF/m), both of the inner and outer conductors can be designed with no influences of disturbances.

The wireless communication circuit 3 receives a wireless communication signal received by an antenna element of the pattern conductor 19, and performs signal processing such as demodulation. In addition, the wireless communication circuit 3 performs processing of modulation of a baseband signal to generate a wireless communication signal to be transmitted by the pattern conductor 19.

FIG. 2A is a plan view showing pattern conductors formed on a first surface 50a of the dielectric substrate 50 of the antenna sensor unit 1 of FIG. 1, and FIG. 2B is a transparent plan view showing pattern conductors depicted with dotted lines, formed on a second surface 50b of the dielectric substrate 50 of the antenna sensor unit 1 of FIG. 1. In this case, the dielectric substrate 50 has the first surface 50a and the second surface 50b which are parallel to each other.

Referring to FIG. 2A, the pattern conductor 11, a sub-pattern conductor 19a of the pattern conductor 19, and a grounding pattern conductor 19ga are formed on the first surface 50a of the dielectric substrate 50. In this case, in this example, the pattern conductor 11 and the sub-pattern conductor 19a are formed such that the respective longitudinal directions thereof are parallel to each other and they are in proximity to each other so as to be electromagnetically coupled with each other. In addition, referring to FIG. 2B, on the second surface 50b of the dielectric substrate 50, the pattern conductors 12 to 15, a sub-pattern conductor 19b of the pattern conductor 19, and a grounding pattern conductor 19gb are formed, and the band rejection filters 17 and 18 and the resistor 16 are mounted.

In this case, another end of the pattern conductor 11 of FIG. 2A is connected with one end of the band rejection filter 17 of FIG. 2B through a via conductor 41 formed by penetrating in a thickness direction of the dielectric substrate 50, and another end of the band rejection filter 17 is connected with one end of the pattern conductor 12. Another end of the pattern conductor 12 is connected with one end of the pattern conductor 13 through the band rejection filter 18, and another end of the pattern conductor 13 is connected with the pattern conductor 15 through the pattern conductor 14 having a meander shape. Further, the pattern conductor 15 is connected with the terminal T31 through the resistor 16.

In addition, another end of the sub-pattern conductor 19a of FIG. 2A is connected with the sub-pattern conductor 19b of FIG. 2B through a via conductor 42. A terminal T19, which is connected with the wireless communication circuit 3, is mounted at a left end portion of the sub-pattern conductor 19b. Further, the grounding pattern conductors 19ga and 19gb are connected through a via conductor 43, and are connected with a terminal T19g.

The electrostatic proximity detection sensor circuit 2 of FIG. 1 generates a burst signal, for example, having several hundred kHz with a predetermined period. The electrostatic proximity sensor circuit 2 transmits the burst signal to the pattern conductors 11, 12, and 13 of the antenna sensor unit 1, which operates as a capacitance detection element. The pattern conductors 11, 12, and 13 are charged upon receiving the burst signal. The electrostatic proximity sensor circuit 2 detects a capacitance value based on the charging state of the pattern conductors 11, 12, and 13. More concretely, the electrostatic proximity sensor circuit 2 detects the voltage of a feedback signal detected at the connection point P1. It is noted that, in the present disclosure, a capacitance detection signal includes the burst signal, and also includes the feedback signal. The electrostatic proximity sensor circuit 2 detects the capacitance at the pattern conductors 11, 12, and 13 based on the voltage of the feedback signal. The electrostatic proximity sensor circuit 2 determines and detects through hardware process whether or not a human body is in proximity to the pattern conductors 11, 12, and 13 within a predetermined threshold distance based on the detected capacitance. When the electrostatic proximity detection sensor circuit 2 detects the proximity of the human body, the electrostatic proximity detection sensor circuit 2 generates and transmits a predetermined detection signal to the controller 10. When the controller 10 receives the predetermined detection signal, the controller 10 controls the wireless communication circuit 3 to reduce the transmitting electric power of the wireless communication signal to be transmitted. It is noted that the controller 10 itself or the wireless communication circuit 3 may have the function of determining based on the capacitance value whether or not a human body is in proximity. More concretely, the controller 10 may acquire a capacitance value or a predetermined voltage value from the electrostatic proximity detection sensor circuit 2, and then, the controller 10 may determine with software processing whether or not a human body is in proximity, based on a threshold held by the controller 10. Alternatively, the controller 10 may merely send the capacitance value to the wireless communication circuit 3, and then, the wireless communication circuit 3 may determine whether or not a human body is in proximity.

In the proximity detection antenna apparatus according to the first embodiment configured as described above, the connection point P1 of a detection electrode is connected with the pattern conductors 11, 12, and 13 in a direct current manner. A signal line for use in this connection is configured by connecting the pattern conductors 11, 12, and 13 through the coaxial cable 30. At this time, design may be made such that a total sum of parasitic capacitance values of the pattern conductors 11 to 15 and the coaxial cable 30, which configure entire sensor structure, is decreased, so that deterioration of a sensor detection distance can be suppressed. More concretely, the design is made, for example, such that the total sum of the parasitic capacitance values is within a range of the capacitance value necessary for operating of the electrostatic proximity detection sensor circuit 2. In order to decrease the total sum of the parasitic capacitance values, the pattern conductors 11 to 15 and the coaxial cable 30 are arranged, for example, in proximity to each other.

FIG. 3 is a circuit diagram showing a configuration of one example of the electrostatic proximity detection sensor circuit 2 of FIG. 1. Referring to FIG. 3, the electrostatic proximity detection sensor circuit 2 includes a controller 20 which controls the operation of this circuit, a clock generator 21, a voltage regulator 22, a comparator 23, a voltage regulator diode D1, a resistor R1, a switch SW, a current mirror circuit 24 including a diode 25 and a current source 26, a sampling capacitor Cs, an electrolytic capacitors C_{VDD} and C_{reg}, and a connection point P1 which is a capacitance detection electrode. In FIG. 3, C_{X} denotes a floating capacitance between the pattern conductors 11, 12, and 13 and the connection point P1, and CT denotes a capacitance generated when a finger of a human touches the pattern conductors 11, 12, and 13 or a human body approaches in proximity with the pattern conductors 11, 12, and 13.

The voltage regulator 22 converts an incoming power source voltage V_{DD} to a predetermined operating voltage. The voltage converted by the voltage regulator 22 is converted to a reference voltage set by the voltage regulator diode D1 through the resistor R1, and the reference voltage is inputted to an inverting input terminal of the comparator and is inputted to the diode 25. In the current mirror circuit 24, a current proportional to the current flowing through the diode 25 flows from the current source 26 to the sampling capacitor Cₛ.

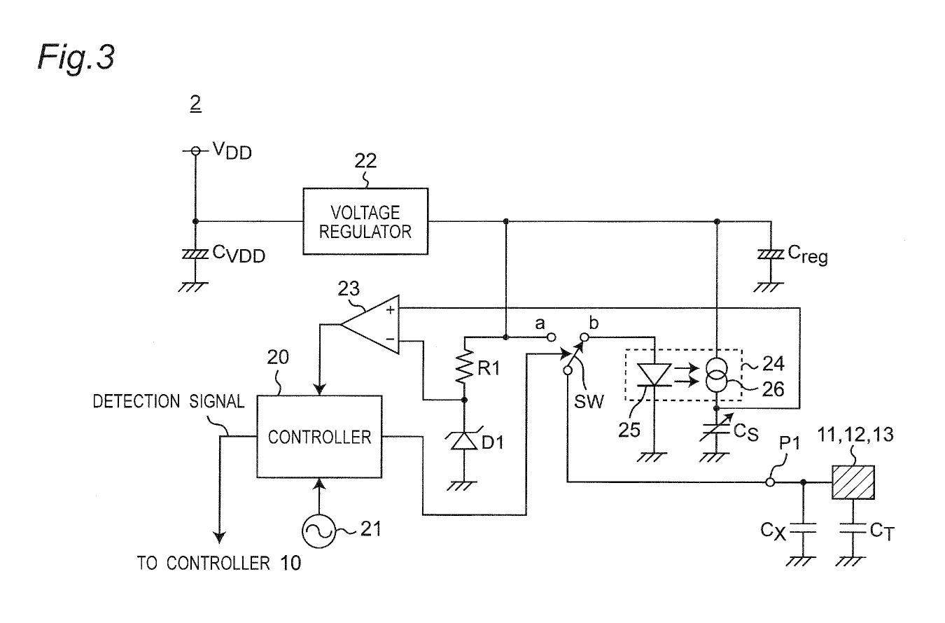

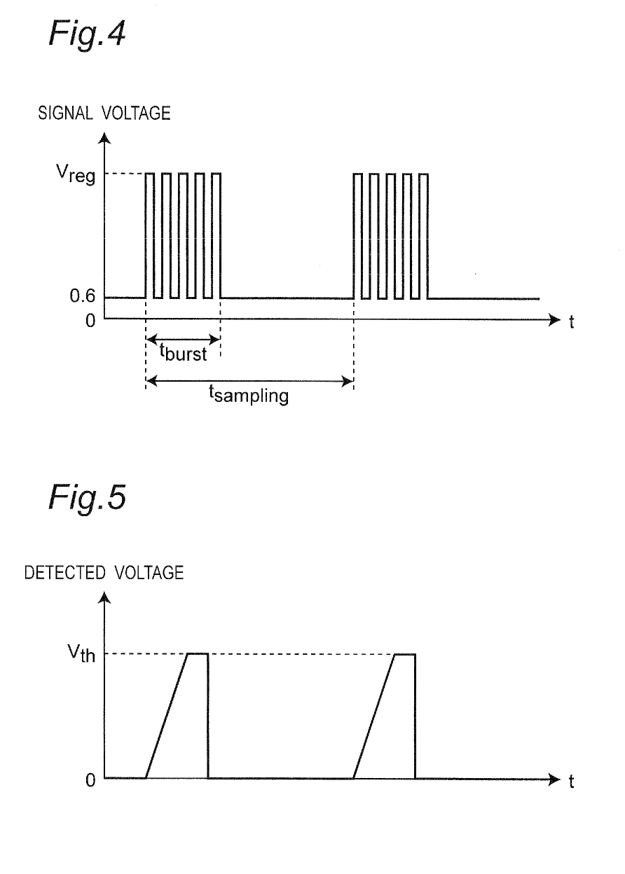

FIG. 4 is a waveform chart showing a signal voltage generated by the electrostatic proximity detection sensor circuit 2 of FIG. 3. FIG. 5 is a waveform chart showing a detected voltage detected by the electrostatic proximity detection sensor circuit 2 of FIGS. 2A and 2B. Referring to FIGS. 3 to 5, the operation of the electrostatic proximity detection sensor circuit 2 of FIG. 4 will be described below.

First of all, the controller 20 switches the switch SW over to a side of a contact point “a”. When the switch SW is switched over to the side of the contact point “a”, a burst signal, for example, of several hundred kHz, having a burst interval t_{burst} is generated periodically with a sampling period t_{sampling}, for example, of about 10 to 1000 milliseconds as shown in FIG. 4, and the generated burst signal is applied from the connection point P1 to the pattern conductors 11, 12, and 13. When the burst signal is applied thereto, the pattern conductors 11, 12, and 13 are charged to have a predetermined voltage. The controller 20 switches the switch SW over to a side of a contact point “b” for a time interval between the burst signals. When the switch SW is switched over to the side of the contact point “b”, the charged voltage is copied to the sampling capacitor Cₛ through the current mirror circuit 24. The comparator 23 compares the sampling capacitor Cₛ with a predetermined reference voltage, and then, the controller 20 determines whether or not a human body is detected according to whether or not the detected voltage exceeds a predetermined threshold voltage Vth, for example, as shown in FIG. 5. When the controller 20 detects a human body, the controller 20 outputs a detection signal to the controller 10. The above-described process is performed periodically with the above-mentioned sampling period t_{sampling}.

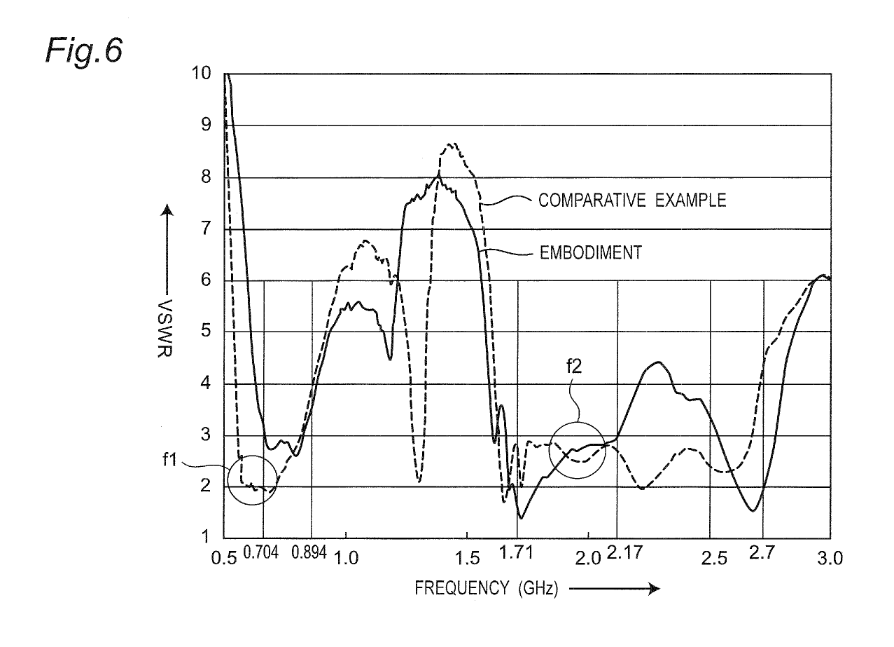

FIG. 6 is a graph showing experimental results of the proximity detection antenna apparatus of FIG. 1 and showing frequency characteristics of a voltage standing wave ratio (VSWR) of the pattern conductor 19 which is an antenna element. In a frequency axis shown as the horizontal axis, frequency bands 704 to 894 MHz, 1710 to 2170 MHz, and 2500 to 2700 MHz are wireless frequencies supported by the antenna apparatus. As shown in FIG. 6, the pattern conductor 19 exhibits excellent characteristics of VSWR<3.5 in the above-mentioned three frequency bands. In a comparative example, since the band rejection filters 17 and 18 are not inserted, unnecessary resonance occurs in these bands f1 and f2. Since the proximity detection antenna apparatus according to the present embodiment includes the band rejection filters 17 and 18, unnecessary resonance in these bands occurs less than the case of the comparative example.

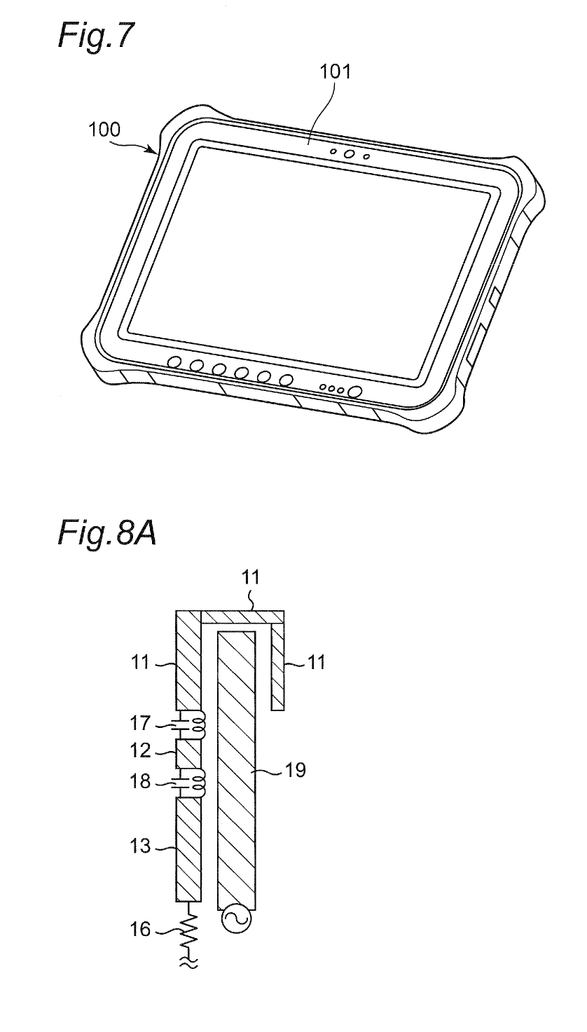

FIG. 7 is a perspective view showing an external view of an electronic tablet 100, which is an electronic apparatus mounting the proximity detection antenna apparatus of FIG. 1 Referring to FIG. 7, the proximity detection antenna apparatus of FIG. 1 is mounted, for example, in an upper peripheral portion 101 of the electronic tablet 100.

As described above, in the present embodiment, the pattern conductor 19 of a wireless antenna element, and the pattern conductors 11, 12, and 13 of the proximity detection sensor circuit 2 are arranged in parallel to each other so as to be electromagnetically coupled with each other. Accordingly, since the sensor element unit extending along the antenna element can detect proximity of a human body and so on in a wide area of a region occupied by the antenna element, no additional space needs to be provided for mounting the sensor circuit. As a result, the entire antenna apparatus can be downsized. In addition, since the sensor element unit is configured by the conductor elements adjacent to the antenna element with a length similar to that of the antenna element, an electrical coupling is generated, and in particular, this leads to a factor affecting high-frequency characteristics used by the antenna. However, since the band rejection filters 17 and 18 and the pattern conductor 14 having a meander shape are inserted between the pattern conductors 11, 12, and 13 and the proximity detection sensor circuit 3, resonance of the capacitance sensor at resonance frequencies of the antenna apparatus can be avoided, and the effect to the antenna performance can be suppressed. In particular, at the resonance frequencies of the band rejection filters 17 and 18, the VSWR of the antenna apparatus can be significantly improved. For example, in the comparative example of FIG. 6, when the antenna element resonates at these frequencies f1 and f2 for use in wireless communication, the sensor element unit also resonates at the frequencies f1 and f2 due to the electrical coupling, and this leads to a factor causing deterioration in the antenna characteristics such as isolation or antenna efficiency. However, in the present embodiment, such a deterioration factor can be reduced. In the present embodiment, each of the band rejection filters 17 and 18 is configured as an LC resonance circuit, but this is merely one example.

As described above, the first embodiment is described as an example of implementation in the present disclosure. However, the present disclosure is not limited to this, and is applicable to embodiments in which modification, substitution, addition, omission, or the like is performed as necessary. In addition, components described in the first embodiment can be combined to provide various embodiments. The other modified embodiments will be described as follows.

### Modified Embodiments

In the embodiments describe above, the coaxial cable 30 of a shield cable is used. However, the present disclosure is not limited to this, and a transmission line such as a micro-strip line may be used.

In the embodiments described above, an example of the electrostatic proximity detection sensor circuit 2 is shown in FIG. 3. However, the present disclosure is not limited to this, and an electrostatic proximity detection sensor circuit having a further circuit configuration may be used.

In the embodiments described above, the pattern conductor for sensor element is divided into three pattern conductors 11, 12, and 13, and two band rejection filters 17 and 18 are inserted between respective adjacent pattern conductors (11 and 12; 12 and 13). However, the pattern conductor for the sensor element may be divided into a plurality of sub-pattern conductors, and band rejection filters having respective predetermined resonance frequencies may be inserted between respective adjacent pattern conductors.

In the embodiments described above, the pattern conductor 11 for the sensor element and the pattern conductor 19 for the antenna element are arranged in proximity to and in parallel to each other so as to electromagnetically couple with each other. However at least one part of the pattern conductors 11, 12, and 13 for the sensor element and at least one part of the pattern conductor 19 may be arranged in proximity to and in parallel to each other.

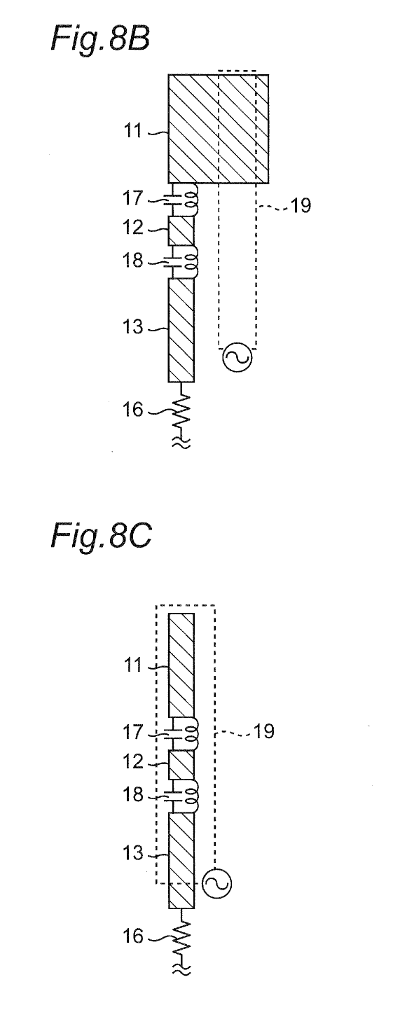

FIGS. 8A, 8B, and 8C are plan views showing modified embodiments of the pattern conductors 11, 12, 13, and 19 of FIG. 1. FIG. 8A is a plan view showing a first modified embodiment of the pattern conductors 11, 12, 13, and 19. Referring to FIG. 8A, the pattern conductors 11, 12, and 13 for sensor element may be arranged so as to surround the pattern conductor 19 for the antenna element. FIG. 8B is a transparent plan view showing a second modified embodiment of the pattern conductors 11, 12, 13, and 19. Referring to FIG. 8B, the pattern conductor 19 for the antenna element and the pattern conductors 11, 12, and 13 for the sensor element may be configured so as to be arranged, respectively, on different layers of the dielectric substrate and to partially overlap each other. FIG. 8C is a transparent plan view showing a third modified embodiment of the pattern conductors 11, 12, 13, and 19. Referring to FIG. 8C, the pattern conductor 19 for antenna element and the pattern conductors 11, 12, and 13 for sensor element may be configured so as to be arranged, respectively, on different layers of the dielectric substrate and to entirely overlap each other. According to the configuration of each of these modified embodiments, since the pattern conductor 19 for the antenna element and the pattern conductors 11, 12, and 13 for the sensor element also can be integrally configured with each other, the space occupied by the wireless apparatus can be reduced.

In addition, the number of the band rejection filters 17 and 18 is not limited to two, and the other band rejection filter(s) may be added and mounted.

In the embodiments described above, the electronic apparatus is an electronic apparatus, such as a personal computer or a mobile phone.

As described above, with the accompanying drawings and the detailed description, the embodiments and other embodiments representing the best mode known to the applicant may be provided. These are provided for exemplifying the matter described in the claims with reference to specific embodiments to show to those skilled in the art. Thus, the components described in the accompanying drawings and the detailed description may include not only the components necessary for solving the problems, but also the other components. Therefore, it should not be construed that such unnecessary components are necessary because such unnecessary components are described in the accompanying drawings or the detailed description. In addition, various modifications, substitution, addition, omission, or the like may be applied to the above described embodiments within the scope of the claims or equivalents thereof

The present disclosure provides an electronic apparatus including a proximity sensor mounted near an antenna in order to detect a peripheral region of a wireless communication antenna that has a relatively high SAR, and achieves avoiding of increasing of the mounting space and prevention of the deterioration in the antenna performance.

What is claimed is:

1. An electronic apparatus comprising:
a first pattern conductor;
a second pattern conductor electromagnetically coupled with the first pattern conductor, the second pattern conductor including a plurality of sub-pattern conductors;
a band rejection filter which connects the plurality of sub-pattern conductors with each other;
a wireless communication circuit with which the first pattern conductor is connected; and
a proximity detection sensor circuit with which the second pattern conductor is connected.

2. The electronic apparatus as claimed in claim 1,
wherein the band rejection filter is a filter which stops a signal in a band in which the first pattern conductor resonates.

3. The electronic apparatus as claimed in claim 1,
wherein the first pattern conductor resonates in a plurality of bands, and
wherein the second pattern conductor includes a plurality of band rejection filters.

4. The electronic apparatus as claimed in claim 1, further comprising a controller configured to control the wireless communication circuit and the proximity detection sensor circuit,
wherein the controller receives a proximity detection signal inputted from the proximity detection sensor circuit, and controls the wireless communication circuit to reduce electric power to be outputted to the first pattern conductor based on the proximity detection signal.

5. The electronic apparatus as claimed in claim 1,
wherein at least one part of the second pattern conductor has a meander shape.

6. The electronic apparatus as claimed in claim 1,
wherein the first pattern conductor and the second pattern conductor are formed on an identical substrate.

7. The electronic apparatus as claimed in claim 6,
wherein at least one part of the first pattern conductor and at least one part of the second pattern conductor are formed in parallel to each other on the substrate.
